(19) United States
(12) Patent Application Publication
(10) Pub. No.: US 2024/0264474 A1
(43) Pub. Date: Aug. 8, 2024

(54) OPTICAL WAVEGUIDE DEVICE AND MANUFACTURING METHOD THEREOF

(71) Applicant: Accelink Technologies Co., Ltd., Wuhan, Hubei (CN)

(72) Inventors: Xuerui LIANG, Wuhan, Hubei (CN); Qianchen YU, Wuhan, Hubei (CN); Li FU, Wuhan, Hubei (CN); Bo ZHANG, Wuhan, Hubei (CN); Yi HU, Wuhan, Hubei (CN); Yong LUO, Wuhan, Hubei (CN); Qianggao HU, Wuhan, Hubei (CN)

(73) Assignee: Accelink Technologies Co., Ltd., Wuhan, Hubei (CN)

(21) Appl. No.: 18/563,022

(22) PCT Filed: Aug. 6, 2021
(86) PCT No.: PCT/CN2021/111284

§ 371 Date: Nov. 21, 2023

(30) Foreign Application Priority Data
Jun. 8, 2021 (CN) 202110638360.4

(51) Int. Cl. G02F 1/035

(52) U.S. Cl. CPC G02F 1/035

(57) ABSTRACT

Disclosed are an optical waveguide device and manufacturing method thereof. The optical waveguide device includes a substrate and an optical modulation module electrically connected with the substrate, the optical modulation module including: an underlay having a first surface relatively close to the substrate and a second surface relatively far away from the substrate, which are provided opposite to each other; an optical waveguide lamination, located between the first surface of the underlay and the substrate, including a lower cladding layer, an optical waveguide layer and an upper cladding layer located between the first surface of the underlay and the optical waveguide layer, which are three stacked in a first direction perpendicular to a plane where the underlay is located; and a conductive structure, located between the optical waveguide layer and the substrate and electrically connected with the optical waveguide layer to conduct an electric signal to the optical waveguide layer.

### CROSS-REFERENCE TO RELATED APPLICATION(S)

The present disclosure claims the priority of a Chinese patent application No. 202110638360.4 filed on Jun. 8, 2021, titled “OPTICAL WAVEGUIDE DEVICE AND MANUFACTURING METHOD THEREOF”, the disclosure of which is hereby incorporated by reference herein in its entirety.

### TECHNICAL FIELD OF THE DISCLOSURE

The invention relates to the technical field of optical communication, in particular to an optical waveguide device and a manufacturing method thereof.

### BACKGROUND

At present, silicon photonics technology is becoming more and more mature, and it has attracted much attention due to its advantages of high integration level, small size, low power consumption, and optoelectronic integration and the like, such as silicon optical modulator. However, when the transmission rate raises to 600 Gb/s or 800 Gb/s or above, the silicon optical modulator still faces the problems, such as insufficient modulation bandwidth, low modulation efficiency, and the like at present. In an application of the silicon optical modulator that the transmission rate exceeds 400 Gb/s, the modulation efficiency needs to be sacrificed to improve the modulation bandwidth, or the modulation bandwidth is reduced to improve the modulation efficiency, both of which cannot realize perfect unification.

Compared with the silicon optical modulator, the lithium niobate-based modulator has higher bandwidth performance. Compared with a traditional bulk material lithium niobite-based modulator, the thin film lithium niobate modulator (TFLN) has the advantages that the waveguide size is smaller, the limiting capacity for the light is higher, the electrode is closer to the waveguide, the effective electric field intensity acting on the crystal is larger, the modulator with high bandwidth and low half wave voltage (Vpi) is easy to be realized, so as to solve the dilemma faced by the silicon optical modulator, thereby meeting the needs of miniaturization and integration of communication. However, the thin film lithium niobate modulator still faces technical challenges such as complex packaging mode. Therefore, how to simplify the packaging process of the thin film lithium niobate modulator has become an urgent technical problem to be solved.

### SUMMARY

In view of the above, the embodiments of the present disclosure provide an optical waveguide device and a manufacturing method thereof.

According to a first aspect of the embodiments of the present disclosure, an optical waveguide device is provided, comprising:
a substrate, and an optical modulation module electrically connected with the substrate;
wherein the optical modulation module comprises:
an underlay, comprising: a first surface and a second surface which are provided opposite to each other; wherein the first surface is relatively close to the substrate, and the second surface is relatively far away from the substrate;
an optical waveguide lamination, which is located between the first surface of the underlay and the substrate, and comprises: a lower cladding layer, an optical waveguide layer and an upper cladding layer which are stacked in a first direction, wherein the first direction is perpendicular to a plane in which the underlay is located, and the lower cladding layer is located between the first surface of the underlay and the optical waveguide layer; and
a conductive structure, which is located between the optical waveguide layer and the substrate, and is electrically connected with the optical waveguide layer, being used for conducting an electric signal to the optical waveguide layer.

In some embodiments, the conductive structure comprises: an input bonding pad, an electrode layer, and an output bonding pad which are provided in parallel in a second direction, wherein the second direction is perpendicular to the first direction, and the second direction is parallel to a plane where the underlay is located.

In some embodiments, the conductive structure further comprises:
a first one of first fixing assembly, which is located between the input bonding pad and the substrate, and which is used for fixedly connecting the input bonding pad and the substrate; and
a second one of first fixing assembly, which is located between the output bonding pad and the substrate, and which is used for fixedly connecting the output bonding pad and the substrate.

In some embodiments, the conductive structure further comprises:
a driving assembly, which is electrically connected with the optical modulation module through the input bonding pad, and which is used for applying a driving signal to the optical modulation module;
a resistance element, which is electrically connected with the optical modulation module through the output bonding pad;
a second fixing assembly, which is located between the driving assembly and the substrate, and which is used for fixedly connecting the driving assembly and the substrate; and
a third fixing assembly, which is located between the resistance element and the substrate, and which is used for fixedly connecting the resistance element and the substrate.

In some embodiments, a compositive material of the optical waveguide layer comprises lithium niobate and lithium tantalite; and
a compositive material of the lower cladding layer and the upper cladding layer comprises silicon oxide or silicon dioxide.

According to a second aspect of the embodiments of the present disclosure, a manufacturing method of an optical waveguide device is provided, comprising:
providing an underlay, wherein the underlay comprises a first surface and a second surface which are provided opposite to each other;
forming an optical waveguide lamination on the first surface of the underlay, wherein the optical waveguide lamination comprises a lower cladding layer, an optical waveguide layer and an upper cladding layer which are stacked in a first direction, and the first direction is perpendicular to a plane in which the underlay is located;
forming a groove penetrating through the upper cladding layer, wherein the bottom of the groove exposes the optical waveguide layer;
forming a conductive structure that fills the groove, wherein the conductive structure is used for conducting an electrical signal to the optical waveguide layer; and
forming a substrate electrically connected with the conductive structure, wherein the first surface is relatively close to the substrate, and the second surface is relatively far away from the substrate.

In some embodiments, the conductive structure comprises: an input bonding pad, an electrode layer, and an output bonding pad provided in parallel in a second direction;
wherein the forming a groove penetrating through the upper cladding comprises:
forming the groove penetrating through the upper cladding in the first direction and extending in the second direction, wherein the second direction is perpendicular to the first direction, and the second direction is parallel to a plane where the underlay is located; and the forming a conductive structure that fills the groove comprises:
depositing a conductive material into the groove, so as to form the input bonding pad, the electrode layer, and the output bonding pad which are provided in parallel in the second direction.

In some embodiments, the forming a substrate electrically connected with the conductive structure comprises:
forming a first one of first fixing assembly on the input bonding pad;
forming a second one of second fixing assembly on the output bonding pad;
inverting the substrate to enable the first surface to be relatively close to the substrate;
fixedly connecting the first one of first fixing assembly with the substrate;
fixedly connecting the second one of first fixing assembly with the substrate.

In some embodiments, the method further comprises:
forming a driving assembly electrically connected with the input bonding pad, wherein the driving assembly is used for applying a driving signal to the optical waveguide layer;
forming a second fixing assembly on the driving assembly;
forming a resistance element electrically connected with the output bonding pad;
forming a third fixing assembly on the driving assembly; and
fixedly connecting the second fixing assembly and the third fixing assembly with the substrate, respectively.

In some embodiments, the forming an optical waveguide lamination on the first surface of the underlay comprises:
forming the lower cladding layer on the first surface of the underlay;
forming an optical waveguide material layer on the lower cladding;
removing part of the optical waveguide material layer by etching so as to form the optical waveguide layer; and
forming the upper cladding layer covering the optical waveguide layer.

In the embodiments of the present disclosure, by providing the conductive structure, electric connection can be established between the optical waveguide layer and the substrate, thereby realizing the three-dimensional (3D) vertical packaging of the optical modulation module and the substrate, reducing the complexity of the packaging of the optical modulation module. As a result, it is beneficial to simplify the packaging process and improves the integration level of the optical modulation module.

In the implementation of the present disclosure, by providing the surface (i.e. the first surface) of the substrate bearing the optical waveguide lamination relatively close to the substrate, the connection path of the electrical signal can be shortened, which is beneficial to reduce the parasitic capacitance and the high-frequency transmission loss and improve transmission rate.

### BRIEF DESCRIPTION OF THE DRAWINGS

In order to more clearly explain the specific embodiments of the present disclosure or the technical solutions in the prior art, the drawings required in the specific embodiments of the present disclosure or the description of the prior art are briefly introduced in the followings. Obviously, the drawings in the following description are some embodiments of the present disclosure, and for those skilled in the art, other drawings may be obtained according to these drawings without any inventive labor.

FIG. 1a and FIG. 1b are schematic structural diagrams of an optical waveguide device according to an embodiment of the present disclosure.

FIG. 2 is a schematic structural diagram of another optical waveguide device according to an embodiment of the present disclosure.

FIG. 3 is a schematic flow diagram of a manufacturing method of an optical waveguide device according to an embodiment of the present disclosure.

FIG. 4a to FIG. 4f are schematic structural diagrams of a manufacturing method of an optical waveguide device according to an embodiment of the present disclosure.

### LIST OF REFERENCE SIGNS

110—substrate
111—fourth fixing assembly
120—optical modulation module
121—underlay
121a—first surface
121b—second surface
122—lower cladding layer
123′—optical waveguide material layer
123—optical waveguide layer
123a—ridge waveguide layer
123b—flat plate layer
124′—upper cladding material layer
124—upper cladding layer
125′—groove
125—conductive structure
51—input bonding pad
52—electrode layer
53—output bonding pad
126—first fixing assembly
126a—first one of first fixing assembly
126b—second one of first fixing assembly
127a—input port
127b—output port
128a—first optical coupler
128b—second optical coupler
130—optical fiber array
131—second fixing assembly
140—resistance element
141—third fixing assembly

### DETAILED DESCRIPTION

The following examples are provided for better understanding of the present disclosure, and they are not limited to the described best embodiments. Moreover, they do not limit the content and protection scope of the present disclosure, and any product that is the same as or similar to the present disclosure obtained by any person under the inspiration of the present disclosure or through combining the present disclosure with other features of the prior art, falls within the protection scope of the present disclosure.

In the description of the present disclosure, it should be noted that the orientation or position relationship indicated by the terms “upper”, “lower”, “inner”, “outer” and the like is based on the orientation or positional relationship shown in the drawings, which is only for the convenience of describing the present disclosure and for simplifying the description, rather than indicating or implying that the referred device or element must have a specific orientation, being constructed and operated in a specific orientation. Therefore, it is not able to be understood as a limitation to the present disclosure. In addition, the terms “first” and “second” are only used for describing purposes and cannot be understood as indicating or implying relative importance.

FIG. 1a and FIG. 1b are schematic structural diagrams of an optical waveguide device 100 according to an embodiment of the present disclosure. FIG. 1a is a cross-sectional view of the optical waveguide device 100, and FIG. 1b is a top view of the optical waveguide device 100. Referring to FIG. 1a, the optical waveguide device 100 comprises: a substrate 110, and an optical modulation module 120 electrically connected with the substrate 110.

The optical modulation module 120 comprises:
an underlay 121, comprising a first surface 121a and a second surface 121b which are oppositely provided, wherein the first surface 121a is relatively close to the substrate 110, and the second surface 121b is relatively far away from the substrate 110;
an optical waveguide lamination, which is located between the first surface 121a of the underlay 121 and the substrate 110, and comprises a lower cladding layer 122, an optical waveguide layer 123 and an upper cladding layer 124 which are stacked in a first direction, wherein the first direction is perpendicular to a plane in which the underlay 121 is located, and the lower cladding layer 122 is located between the first surface 121a of the underlay 121 and the optical waveguide layer 123; and
a conductive structure 125, which is located between the optical waveguide layer 123 and the substrate 110, and is electrically connected with the optical waveguide layer 123 for conducting an electric signal to the optical waveguide layer 123.

Exemplarily, with reference to FIG. 1a, the optical waveguide lamination comprises a lower cladding layer 122, an optical waveguide layer 123 and an upper cladding layer 124 which are stacked sequentially in a negative direction of an x-axis. And the lower cladding layer 122 is located between the first surface 121a of the underlay 121 and the optical waveguide layer 123. The optical waveguide layer 123 may further comprise a continuous structure (defined as a flat plate layer) extending in a z direction, and a spaced structure (defined as a ridge waveguide layer) provided in parallel in the z direction. The upper cladding layer 124 is located on the flat plate layer and covers the ridge waveguide layer.

Here, the first direction is defined as a x direction, the second direction is a y direction, the third direction is the z direction, and the x direction is perpendicular to a yoz plane (i.e. the plane where the underlay 121 is located), which will not be repeated thereafter.

The conductive structure 125 is provided at intervals in the z direction, which is located between two adjacent ridge waveguide layers. In the x direction, the conductive structure 125 is located between a flat plate layer of the optical waveguide layer 123 and the substrate 110, and is in contact with the flat plate layer for conducting an electric signal to the optical waveguide layer 123.

The substrate 110 comprises a packaging substrate used for bearing the optical waveguide device 100. For example, a low temperature co-fired ceramic (LTCC) substrate or a printed circuit board (PCB).

A compositive material of the underlay 121 comprises: an elemental semiconductor material (e.g. silicon, germanium), a group III-V compound semiconductor material, a group II-VI compound semiconductor material, an organic semiconductor material, or other semiconductor materials known in the art.

A compositive material of the lower cladding layer 122 and the upper cladding layer 124 comprises silicon oxide or silicon dioxide. The thickness of the lower cladding layer 122 and the thickness of the upper cladding layer 124 are both greater than 3 microns, and the thickness of the lower cladding layer 122 and the thickness of the upper cladding layer 124 may be the same or different.

A compositive material of the optical waveguide layer 123 comprises lithium niobate and lithium tantalate. The optical waveguide layer 123 comprises a flat plate layer and a ridge waveguide layer. The thickness range of the flat plate layer is 0.1 microns to 5 microns. The thickness range of the ridge waveguide layer is 0.1 microns to 5 microns. The thickness of the flat plate layer and the thickness of the ridge waveguide layer are approximately the same; for example, their thicknesses are equal or close to each other.

A compositive material of the conductive structure comprises a conductive material, for example, metal material such as gold, copper, or aluminum. The thickness range of the conductive structure is 0.3 microns to 10 microns.

In the embodiment of the present disclosure, by providing the conductive structure, electric connection can be established between the optical waveguide layer and the substrate, thereby realizing the three-dimensional (3D) vertical packaging of the optical modulation module and the substrate, reducing the complexity of the packaging of the optical modulation module. As a result, it is beneficial to simplify the packaging process, and improves the integration level of the optical modulation module.

In the related technology, the end face inverted cone coupler needs to limit the light by means of the upper cladding layer and the lower cladding layer, so as to realize the mode field beam expansion. However, the deposition of the upper cladding layer affects the electrical connection of the traveling wave electrode, and the metal via hole penetrating through the upper cladding needs to be manufactured to realize electrical connection of the traveling wave electrode. The via hole involves a complex process and a highly difficult manufacturing, and the resistance-capacitance-reactance additionally introduced by the via hole will reduce the bandwidth of the traveling wave electrode, and the integrity of the signal is only limited to two dimensions, so that the application of the optical waveguide device is limited at 800 Gb/s.

Compared with the mode of providing the metal via hole in the related technology, the embodiments of the present disclosure provide the conductive structure, while realizing a better electrical connection between the conductive structure and the substrate, thereby reducing the manufacturing complexity difficulty of the structure used for leading the optical waveguide layer out to the substrate.

Further, by providing the surface (i.e. the first surface) of the substrate bearing the optical waveguide lamination relatively close to the substrate, the connection path of the electrical signal can be shortened, which is beneficial to reducing the parasitic capacitance and the high-frequency transmission loss.

In some embodiments, referring to FIG. 1b, the conductive structure 125 comprises:
an input bonding pad 51, an electrode layer 52, and an output bonding pad 53 provided in parallel in a second direction, wherein the second direction is perpendicular to the first direction, and the second direction is parallel to a plane where the underlay 121 is located.

Exemplarily, referring to FIG. 1b, the optical modulation module 120 comprises two ridge waveguide layers 123a provided at intervals in the z direction and extending in the y direction. In the direction parallel to the z direction, the electrode layer 52 is located between two adjacent ridge waveguide layers 123a. In the direction parallel to the y direction, the input bonding pad 51 and the output bonding pad 53 are respectively located at both ends of the electrode layer 52; for example, the input bonding pad 51 is located on the left side of the electrode layer 52, and the output bonding pad 53 is located on the right side of the electrode layer 52.

The compositive material of the input bonding pad 51, the electrode layer 52, and the output bonding pad 53 comprises a conductive material, for example, a metal material such as gold, copper, or aluminum. The compositive material between any two of the input bonding pad 51, the electrode layer 52 and the output bonding pad 53 may be the same or different. When the compositive materials of the input bonding pad 51, the electrode layer 52, and the output bonding pad 53 are the same, they may be formed in one process at the same time.

It can be understood that in the embodiments of the present disclosure, the conductive structure 125 is a continuous structure extending in the y direction and may comprise a plurality of sub-conductive structures, and the sub-conductive structures thereof located on both sides of the ridge waveguide layer 123a may be used as the electrode layer 52.

Compared with a strip-shaped traveling wave electrode in the related technology, the embodiments of the present disclosure provides electrode layers on both sides of the ridge waveguide layer, which can increase the width of the electrode layer in the second direction and is beneficial to reducing the difficulty of manufacturing for the electrode layer.

In addition, by providing the electrode layer, the resistive-capacitive-reactance of the electrode layer as a traveling wave electrode can be reduced, which is beneficial to improving the bandwidth of the optical modulation module, reducing the possibility that the optical modulation module is limited in the application with the transmission rate exceeding 800 Gb/s, and further widening the application range thereof.

In some embodiments, referring to FIG. 1b, the optical waveguide device 100 further comprises:

a first one of first fixing assembly 126a, wherein it is located between the input bonding pad 51 and the substrate 110, which is used for fixedly connecting the input bonding pad 51 and the substrate 110;

a second one of first fixing assembly 126b, wherein it is located between the output bonding pad 53 and the substrate 110, which is used for fixedly connecting the output bonding pad 53 and the substrate 110.

Exemplarily, referring to FIG. 1a, the first fixing assembly 126 is located between the optical modulation module 120 and the substrate 110, which is used for fixing the optical modulation module 120 and the substrate 110.

Exemplarily, referring to FIG. 1b, the first fixing assembly 126 comprises a plurality of the first one of first fixing assemblies 126a provided in parallel in the z direction and a plurality of the second one of first fixing assemblies 126b provided in parallel in the z direction. The first one of first fixing assembly 126a is located between the output bonding pad 53 and the substrate 110, which is used for fixedly connecting the output bonding pad 53 and the substrate 110. The second one of first fixing assembly 126b is located between the output bonding pad 53 and the substrate 110, which is used for fixedly connecting the output bonding pad 53 and the substrate 110.

It can be understood that the first one of first fixing assembly 126a and the second one of first fixing assembly 126b both represent a first fixing assembly 126, which is used for fixing the optical modulation module 120 on the substrate 110. The different reference signs are merely intended to distinguish differences in the position of the first fixing assembly, without having to be used to describe a specific order or precedence order.

In some embodiments, the projections of the first one of first fixing assembly 126a and the second one of first fixing assembly 126b on the xoz plane are overlapped each other or partially overlapped each other.

The compositive material of the first fixing assembly 126 comprises a solder material, for example, tin-lead solder or eutectic soldering tin.

In the present disclosed embodiment, by providing a plurality of first fixing assemblies on both sides of the optical modulation module which are oppositely provided in the y direction, a fixed connection between the optical modulation module and the substrate can be realized, and the stability and reliability of the package of the optical modulation module can be improved.

In addition, when the first fixing assembly comprises a solder ball, a high-frequency electrical connection between the optical modulation module and the substrate can be realized, thereby reducing the loss of the transmitted signal.

In some embodiments, referring to FIG. 1a, the optical waveguide device 100 further comprises:
a driving assembly 130, which is electrically connected with the optical modulation module 120 through the input bonding pad 51, and which is used for applying a driving signal to the optical modulation module 120;
a resistance element 140, which is electrically connected with the optical modulation module 120 through the output bonding pad 53;
a second fixing assembly 131, which is located between the driving assembly 130 and the substrate 110, and which is used for fixedly connecting the driving assembly 130 and the substrate 110;
a third fixing assembly 141, which is located between the resistance element 140 and the substrate 110, and which is used for fixedly connecting the resistance element 140 and the substrate 110.

The driving assembly 130 comprises a modulator driver, for example, electric drive chips.

The resistance element 140 comprises a terminal matching resistance, for example, 50Ω terminal matching resistance.

A compositive material of the second fixing assembly 131 and the third fixing assembly 141 comprises a solder material, for example, tin-lead solder or eutectic soldering tin. The compositive material of any two between the first fixing assembly 126, the second fixing assembly 131 and the third fixing assembly 141 may be the same or different.

It can be understood that in the embodiments of the present disclosure, when the compositive materials of the first fixing assembly, the second fixing assembly and the third fixing assembly are the same, the optical modulation module, the driving assembly and the resistance element can be fixed on the substrate 110 at the same time, which is beneficial to reducing the production cost of the optical waveguide device.

In some embodiments, referring to FIG. 1b, the optical waveguide device 100 further comprises an input port 127a and an output port 127b provided in parallel in a third direction, wherein
the input port 127a is respectively connected with an optical emission module and the optical modulation module, and which is used for conducting an input optical signal; and
the output port 127b is respectively connected with the optical modulation module and the optical detection module, and which is used for conducting an output optical signal.

Exemplarily, referring to FIG. 1b, a left end of the input port 127a may be connected with the optical emission module (not shown in the figure), and a right end of the input port 127a is connected with a first optical coupler 128a which is used for conducting an optical signal emitted by the optical emission module to a ridge waveguide layer 123a through the input port 127a and the first optical coupler 128a.

Exemplarily, referring to FIG. 1b, a left end of the output port 127b may be connected with the optical detection module (not shown in the figure), and a right end of the input port 127a is connected with a second optical coupler 128b, which is used for conducting an optical signal modulated by the optical modulation module to the optical detection module through the second optical coupler 128b and the output port 127b.

The optical emission module comprises a laser (LD), for example, a semiconductor laser.

The optical detection module comprises a photoelectric detector (PD), for example, a photodiode, a photomultiplier or a phototriode.

In the embodiment of the present disclosure, by providing the input port and the output port on the same side of the optical modulation module, the size of the optical waveguide device in the y direction can be reduced, which is beneficial to improving the integration level of the optical waveguide device.

In some embodiments, with reference to FIG. 1a, the substrate 110 comprises a plurality of fourth fixing assemblies 111, wherein the fourth fixing assembly 111 and the optical modulation module 120 are located on both sides of the substrate 110 which are provided opposite to each other, and the melting temperature of the first fixing assembly 126 is greater than the melting temperature of the fourth fixing assembly 111.

It should be pointed out that after the optical modulation module 120 and the substrate 110 are fixedly connected through the first fixing assembly 126, the optical waveguide device also needs to perform other packaging processes. In the embodiments of the present disclosure, by providing the melting temperature of the first fixing assembly 126 be greater than the melting temperature of the fourth fixing assembly 111, when the optical waveguide device performs other packaging process through the fourth fixing assembly 111, the probability of melting backflow of the first fixing assembly can be reduced, and the influence on the optical modulation module after the first fixing assembly is melted is reduced.

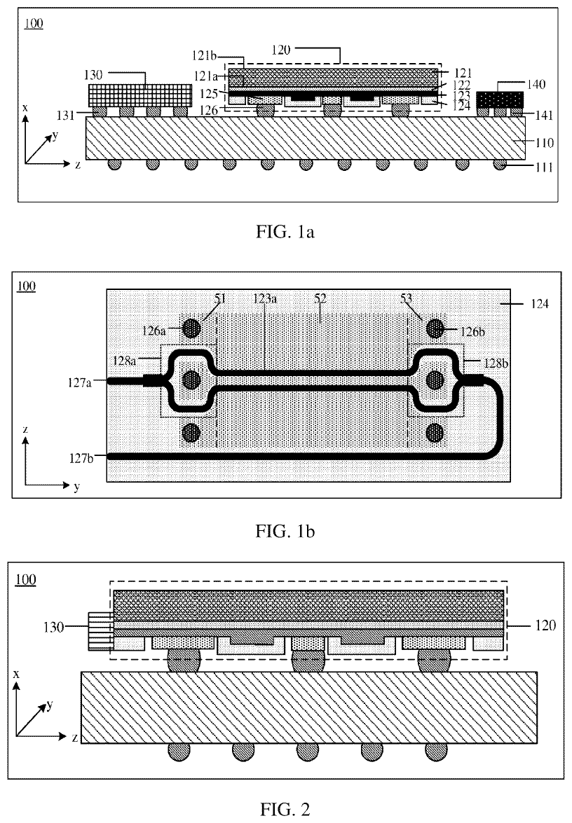

In some embodiments, referring to FIG. 2, the optical waveguide device 100 further comprises an optical fiber array 130, which is used for conducting an optical signal.

Exemplarily, the optical fiber array 130 may comprise an input optical fiber array and an output optical fiber array. The input optical fiber array is located between the optical emission module and the input port 127a, which is used for conducting an optical signal emitted by the optical emission module to the input port 127a. The output optical fiber array is located between the output port 127b and the optical detection module, which is used for conducting the optical signal output by the output port 127b to the optical detection module. It can be understood that the projections of the input optical fiber array and the output optical fiber array on the xoy plane are overlapped each other or partially overlapped each other.

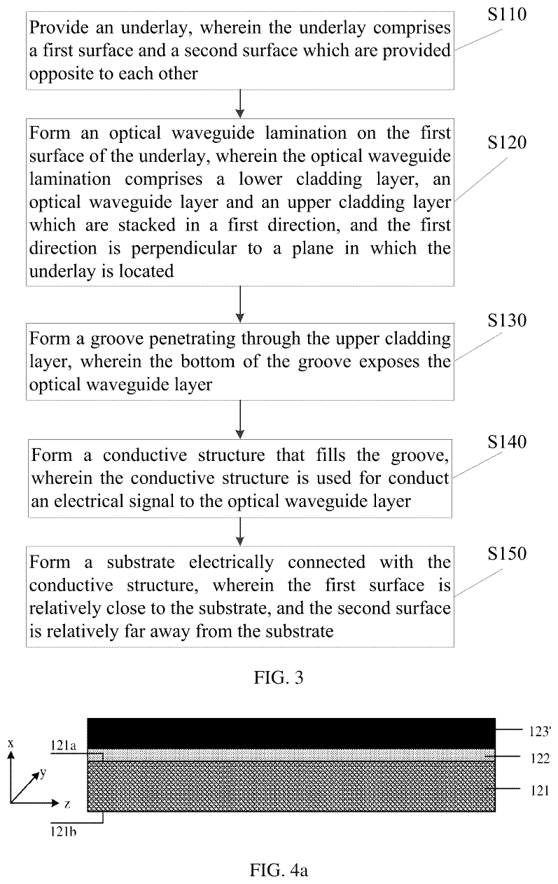

FIG. 3 is a schematic flowchart of a manufacturing method of an optical waveguide device according to an embodiment of the present disclosure. Referring to FIG. 3, a manufacturing method which are used for making an optical waveguide device 100 provided in the present embodiment comprises:
Step 110: providing an underlay, wherein the underlay comprises a first surface and a second surface which are provided opposite to each other;
Step 120: forming an optical waveguide lamination on the first surface of the underlay, wherein the optical waveguide lamination comprises a lower cladding layer, an optical waveguide layer and an upper cladding layer which are stacked in a first direction, and the first direction is perpendicular to a plane in which the underlay is located;
Step 130: forming a groove penetrating through the upper cladding layer, wherein the bottom of the groove exposes the optical waveguide layer;
Step 140: forming a conductive structure that fills the groove, wherein the conductive structure is used for conduct an electrical signal to the optical waveguide layer;
Step 150: forming a substrate electrically connected with the conductive structure, wherein the first surface is relatively close to the substrate, and the second surface is relatively far away from the substrate.

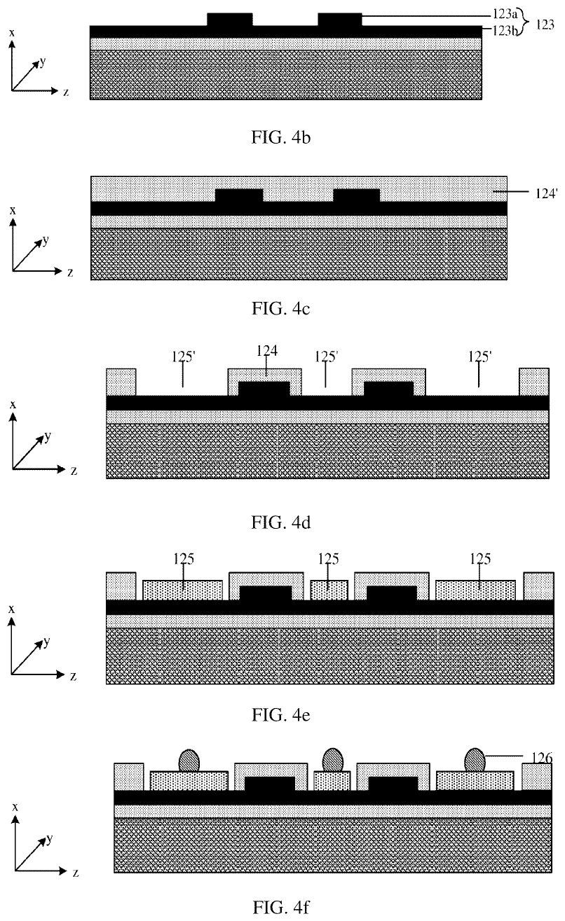

FIG. 4a to FIG. 4f are schematic structural diagrams of a manufacturing method of an optical waveguide device according to an embodiment of the present disclosure. The embodiments of the present disclosure will be described in further detail below in combined with FIG. 3 and FIG. 4a to FIG. 4f.

Firstly, referring to FIG. 4a, executing Step 110: providing an underlay 121, wherein the underlay 121 comprises a first surface 121a and a second surface 121b which are provided opposite to each other.

A compositive material of the underlay 121 comprises an elemental semiconductor material (e.g. silicon, germanium), a group III-V compound semiconductor material, a group II-VI compound semiconductor material, an organic semiconductor material, or other semiconductor materials known in the art.

Next, referring to FIG. 4a to FIG. 4c, executing Step 120: forming an optical waveguide lamination on the first surface of the underlay, wherein the optical waveguide lamination comprises a lower cladding layer, an optical waveguide layer and an upper cladding layer which are stacked in a first direction, and the first direction is perpendicular to a plane in which the underlay is located.

Exemplarily, an optical waveguide lamination may be formed on the first surface 121a of the underlay 121 through a thin film deposition process. The thin film deposition process comprises, but is not limited to, a chemical vapor deposition (CVD) process, a plasma enhanced chemical vapor deposition process (PECVD), an atomic layer deposition (ALD) process, or a combination thereof.

In some embodiments, the forming an optical waveguide lamination on the first surface of the underlay comprises:
forming the lower cladding layer on the first surface of the substrate;
forming an optical waveguide material layer on the lower cladding;
removing a part of the optical waveguide material layer by etching, so as to form the optical waveguide layer; and
forming the upper cladding covering the optical waveguide layer.

Exemplarily, referring to FIG. 4a, the lower cladding layer 122 is formed on the first surface 121a of the substrate 121, and an optical waveguide material layer 123′ is formed on the lower cladding 122.

Exemplarily, referring to FIG. 4b, in a direction parallel to the x-axis, a part of the optical waveguide material layer 123′ are removed by etching downward, so as to form an optical waveguide layer 123 as shown in FIG. 4b. The optical waveguide layer 123 may comprise a flat plate layer 123b extending in the z direction, and a plurality of ridge waveguide layers 123a provided in parallel to the z direction, and the ridge waveguide layer 123a extends in the y direction.

The etching process comprises a plasma dry etching process, for example, inductively coupled plasma etching (ICP) or reactive ion etching (RIE).

Exemplarily, referring to FIG. 4c, an upper cladding material layer 124′ covering the optical waveguide layer 123 is formed.

A compositive material of the lower cladding 122 and the upper cladding material layer 124′ comprises silicon oxide or silicon dioxide.

A compositive material of the optical waveguide material layer 123′ comprises lithium niobate and lithium tantalate.

Next, referring to FIG. 4d, executing Step 130: forming a groove 125′ penetrating through the upper cladding material layer 124′, wherein the bottom of the groove 125′ exposes the optical waveguide layer 123.

Exemplarily, referring to FIG. 4b, in the direction parallel to the x direction, the upper cladding material layer 124′ is etched downward, so as to form a plurality of the grooves 125′ provided in parallel in the z direction. The groove 125′ penetrates through the upper cladding material layer 124′, and the bottom exposes the flat plate layer 123b. Each groove 125′ is located between two adjacent ridge waveguide layers 123a, and is not in contact with the ridge waveguide layer 123a.

Next, referring to FIG. 4e, executing Step S140: forming a conductive structure 125 that fills the groove 125′, wherein the conductive structure 125 is used for conduct an electrical signal to the optical waveguide layer 123.

In some embodiments, the conductive structure comprises: an input bonding pad, an electrode layer, and an output bonding pad provided in parallel in a second direction;
the forming a groove penetrating through the upper cladding layer comprises:
forming the groove penetrating through the upper cladding layer in the first direction and extending in the second direction, wherein the second direction is perpendicular to the first direction, and is parallel to a plane where the underlay is located;
the forming a conductive structure that fills the groove comprises:
depositing a conductive material into the groove, so as to form the input bonding pad, the electrode layer, and the output bonding pad provided in parallel to the second direction.

Exemplarily, referring to FIG. 4d, the upper cladding material layer 124′ is etched downward parallel to the x-axis, forming a plurality of grooves 125′ penetrating through the upper cladding material layer 124′ in the x direction and extending in the y direction. It can be understood that a plurality of grooves 125′ separate the upper cladding material layer 124′ into a plurality of independent upper cladding layers 124, and each upper cladding 124 covers the ridge waveguide layer 123a.

Exemplarily, referring to FIG. 4e, the conductive material is deposited into the groove 125′, so as to form the conductive structure 125 extending in the y direction. Combined with FIG. 1b, the conductive structure 125 may comprise a plurality of sub-conductive structures, respectively corresponding to the input bonding pad, the electrode layer, and the output bonding pad.

The compositive material of the conductive structure 125 comprises a conductive material, for example, a metal material such as gold, copper, or aluminum.

Finally, executing Step 150: forming a substrate electrically connected with the conductive structure, wherein the first surface is relatively close to the substrate, and the second surface is relatively far away from the substrate.

In some embodiments, the forming a substrate electrically connected with the conductive structure comprises:
forming a first one of first fixing assembly on the input bonding pad;
forming a second one of second fixing assembly on the output bonding pad;
inverting the substrate to enable the first surface to be relatively close to the substrate;
fixedly connecting the first one of first fixing assembly with the substrate;
fixedly connecting the second one of first fixing assembly with the substrate.

Exemplarily, referring to FIG. 4f, a first fixing assembly 126 is formed on the conductive structure 125, and the substrate 121 is inverted, so that the first surface 121a of the underlay 121 is relatively close to the substrate 121 and fixedly connecting the first fixing assembly 126 with the substrate, so as to form the optical waveguide device as shown in FIG. 1a.

Exemplarily, a first one of first fixing assembly is formed on the input bonding pad (i.e. one end of the conductive structure in the y direction), and a second one of second fixing assembly is formed on the output bonding pad (i.e. the other end of the conductive structure in the y direction).

It can be understood that the first one of first fixing assembly and the second one of first fixing assembly both represent the first fixing assembly, and the projections of the first one of first fixing assembly and the second one of first fixing assembly on the xoz plane are overlapped each other.

The compositive material of the first fixing assembly 126 comprises a solder material, for example, tin-lead solder or eutectic soldering tin.

In some embodiments, the above-mentioned method further comprises:
forming a driving assembly electrically connected with the input bonding pad, wherein the driving assembly is used for applying a driving signal to the optical waveguide layer;
forming a second fixing assembly on the driving assembly;
forming a resistance element electrically connected with the output bonding pad;
forming a third fixing assembly on the driving assembly; and
fixedly connecting the second fixing assembly and the third fixing assembly with the substrate, respectively.

Exemplarily, the electric connection between the driving assembly and the input bonding pad can be realized by forming the first lead, and the electric connection between the resistance element and the output bonding pad can be realized through forming the second lead.

Exemplarily, when a first fixing assembly 126 is formed on the conductive structure 125, the second fixing assembly can be formed on the driving assembly and the third fixing assembly can be formed on the resistance element, and thus the first fixing assembly, the second fixing assembly and the third fixing assembly can be formed at the same time in the same process, and then the first fixing assembly, the second fixing assembly and the third fixing assembly are fixedly connected with the substrate respectively.

In other embodiments, the first fixing assembly can be firstly formed on the conductive structure, and is fixedly connected with the substrate, then the second fixing assembly is formed on the driving assembly, and is fixedly connected with the substrate, and finally, the third fixing assembly is formed on the resistance element, and is fixedly connected with the substrate.

It can be understood that the optical modulation module, the driving assembly and the resistance element can be welded to the substrate at the same time, and can also be welded to the substrate one after another. Herein the present disclosed embodiments do not make limitation to them.

Obviously, the above-mentioned embodiments are merely examples made for clearly description, rather than the definition to the embodiments. For those skilled in the art, other different forms of changes or variations can be made on the basis of the above-mentioned description. It is not necessary and impossible to exhaust all of the embodiments here. However, the obvious changes or variations derived therefrom are still within the protection scope created by the present disclosure.

1. An optical waveguide device, comprising a substrate and an optical modulation module electrically connected with the substrate;
wherein the optical modulation module comprises:
an underlay, comprising a first surface and a second surface which are provided opposite to each other, wherein the first surface is relatively close to the substrate, and the second surface is relatively far away from the substrate;
an optical waveguide lamination, which is located between the first surface of the underlay and the substrate, and comprises a lower cladding layer, an optical waveguide layer and an upper cladding layer which are stacked in a first direction, wherein the first direction is perpendicular to a plane in which the underlay is located, and the lower cladding layer is located between the first surface of the underlay and the optical waveguide layer; and
a conductive structure, which is located between the optical waveguide layer and the substrate, and is electrically connected with the optical waveguide layer, being used for conducting an electric signal to the optical waveguide layer.

2. The optical waveguide device of claim 1, wherein the conductive structure comprises:
an input bonding pad, an electrode layer, and an output bonding pad provided in parallel in a second direction, wherein the second direction is perpendicular to the first direction, and the second direction is parallel to a plane where the underlay is located.

3. The optical waveguide device of claim 2, wherein the conductive structure further comprises:
a first one of first fixing assembly, which is located between the input bonding pad and the substrate, and which is used for fixedly connecting the input bonding pad and the substrate; and
a second one of first fixing assembly, which is located between the output bonding pad and the substrate, and which is used for fixedly connecting the output bonding pad and the substrate.

4. The optical waveguide device of claim 2, wherein the conductive structure further comprises:
a driving assembly, which is electrically connected with the optical modulation module through the input bonding pad, and which is used for applying a driving signal to the optical modulation module;
a resistance element, which is electrically connected with the optical modulation module through the output bonding pad;
a second fixing assembly, which is located between the driving assembly and the substrate, and which is used for fixedly connecting the driving assembly and the substrate; and
a third fixing assembly, which is located between the resistance element and the substrate, and which is used for fixedly connecting the resistance element and the substrate.

5. The optical waveguide device of claim 1, wherein
a compositive material of the optical waveguide layer comprises lithium niobate and lithium tantalite; and
a compositive material of the lower cladding layer and the upper cladding layer comprises silicon oxide or silicon dioxide.

6. A manufacturing method of an optical waveguide device, comprising:
providing an underlay, wherein the underlay comprises a first surface and a second surface which are provided opposite to each other.
forming an optical waveguide lamination on the first surface of the underlay, wherein the optical waveguide lamination comprises a lower cladding layer, an optical waveguide layer and an upper cladding layer which are stacked in a first direction, and the first direction is perpendicular to a plane in which the underlay is located;
forming a groove penetrating through the upper cladding, wherein the bottom of the groove exposes the optical waveguide layer;
forming a conductive structure that fills the groove, wherein the conductive structure is used for conduct an electrical signal to the optical waveguide layer; and
forming a substrate electrically connected with the conductive structure, wherein the first surface is relatively close to the substrate, and the second surface is relatively far away from the substrate.

7. The method of claim 6, wherein the conductive structure comprises an input bonding pad, an electrode layer, and an output bonding pad which are provided in parallel in a second direction;
the forming a groove penetrating through the upper cladding comprises:
forming the groove penetrating through the upper cladding layer in the first direction and extending in the second direction, wherein the second direction is perpendicular to the first direction, and is parallel to a plane where the underlay is located;
the forming a conductive structure that fills the groove comprises:
depositing a conductive material into the groove, so as to form the input bonding pad, the electrode layer, and the output bonding pad provided in parallel in the second direction.

8. The method of claim 7, wherein the forming a substrate electrically connected with the conductive structure comprises:
forming a first one of first fixing assembly on the input bonding pad;
forming a second one of first fixing assembly on the output bonding pad;
inverting the substrate to enable the first surface to be relatively close to the substrate;
fixedly connecting the first one of first fixing assembly with the substrate;
fixedly connecting the second one of first fixing assembly with the substrate.

9. The method of claim 7, wherein the method further comprises:
forming a driving assembly electrically connected with the input bonding pad, wherein the driving assembly is used for applying a driving signal to the optical waveguide layer;
forming a second fixing assembly on the driving assembly;
forming a resistance element electrically connected with the output bonding pad;
forming a third fixing assembly on the driving assembly; and
fixedly connecting the second fixing assembly and the third fixing assembly with the substrate, respectively.

10. The method of claim 6, wherein the forming an optical waveguide lamination on the first surface of the underlay comprises:
forming the lower cladding layer on the first surface of the substrate;
forming an optical waveguide material layer on the lower cladding layer;
removing a part of the optical waveguide material layer by etching so as to form the optical waveguide layer; and
forming the upper cladding layer covering the optical waveguide layer.
